(19) United States
(12) Patent Application Publication
(10) Pub. No.: US 2014/0260770 A1
(43) Pub. Date: Sep. 18, 2014

(54) MANOEUVRING ELEMENT WITH INTEGRATED LOCKING MEANS

(71) Applicant: ELESA S.p.A., Milano (IT)

(72) Inventor: Alberto Bertani, Monza (IT)

(73) Assignee: ELESA S.p.A., Milano (IT)

(21) Appl. No.: 14/204,381

(22) Filed: Mar. 11, 2014

(30) Foreign Application Priority Data
Mar. 12, 2013 (IT) MI2013U000086

(51) Int. Cl. G05G 1/08; G05G 1/10

(52) U.S. Cl. CPC G05G 1/085; G05G 1/10
USPC 74/523

(57) ABSTRACT

Manoeuvring element of the type consisting of a crank provided at one end with a protruding handle and at the other end with manoeuvring which actuate a rotation transmission shaft and furthermore provided with a safety system, consisting of button means housed within a cavity obtained in said crank for the actuation of a locking pin characterised in that with said button means there are associated retaining means of said locking pin axially controlled by said button means and apt to rotate between a fastening position and an unlocking position.

The present invention relates to a manouvring element with integrated locking means apt to control the prevention of the rotation thereof.

### BACKGROUND

Such devices have been known for a long time and for a wide variety of uses and applications, in particular on machinery or equipment. Generically, they consist of a usually circular crown, from which gripping and manoeuvring means depart, possibly provided with a handle.

Depending on various requirements, the devices on the market may have or not, elements for halting the rotation of the manoeuvring shaft.

For the displacement of the moving body on which the manoeuvring element is mounted to occur only in conditions of maximum safety, and only by authorised operators, pressure-activated safety means which may be controlled from the outside are provided, to engage—when activated—the structure on which the element is mounted and prevent the rotation thereof. At the moment, such means consist of an axially moving, outwardly protruding plunger carrying internally at least a protruding pin and, in the structure on which the element is mounted, a plurality of holes apt to receive said pins.

If required, the manoeuvring element is provided with a lock of the axial movements thereof, for example in case one wants to avoid tampering or displacement errors.

As is understandable from the above-reported description, the safety means are structured so that—upon the actuation of the manoeuvring element—they protrude from the manoeuvring element, risking to cause logistics problems, since this type of devices is often provided in cramped spaces, where also a small bulk takes up significant importance.

### BRIEF SUMMARY

The object of the invention is therefore to accomplish a manouvring element provided with safety means in which bulk is kept constant, both during movement and at rest.

Said object is achieved through a manoeuvring element having the features according to claim 1).

### BRIEF DESCRIPTION OF DRAWINGS

The element is now going to be described in greater detail, exclusively as an example with reference to the attached drawings, wherein:

FIG. 1 is a top plan perspective view of a manoeuvring element according to the invention;

FIG. 2 is a longitudinal section view of the manoeuvring element of FIG. 1;

FIGS. 3a to 3e are views of the main elements which form the button body of the manoeuvring element according to the invention;

FIGS. 4a to 4c are views of the detail D of FIG. 2, wherein the operation of the safety system of the manoeuvring element according to the invention is highlighted.

### DETAILED DESCRIPTION

Manoeuvring element 1 consists of a crank 2, provided at one end of a protruding handle 3 and at the other end of the manoeuvring means 4 on which the above-said element 1 is applied which drive a rotation transmission shaft (not shown) inserted in a central shaped cavity 4a. A safety system is furthermore provided, consisting of a button 5, housed in a cavity 4b, and of a lock assembly 6, housed in cavity 4c, said button 5 and said lock assembly 6 being mutually symmetrical with respect to the x-x axis shown in FIG. 2.

More specifically, engaging means 4 consist of a hollow bush, kept in a stable position by a pair of annular, mutually parallel ribbings 7, 8, and aimed at maintaining bush 4 in the desired position.

In order to avoid the entry of dust in the transmission system, a closing cap 9 is finally provided in correspondence of the upper surface of manoeuvring element 1.

Button body 5 consists of a cylindrical body, open below, provided on the lateral surface with ribbings 5a for the engagement with grooves 4d, complementary thereto, provided along the walls of cavity 4b. A glass 5b projects from the inner surface of the upper wall, the object of which is better described in the following. Likewise, finally, the annular bottom surface 5c of button body 5 has a wavy pattern, the object of which will be better understood in the following.

In engagement with button means 5 is a centrally drilled rotating insert 10 externally provided with equidistant pins 10a, the top of which has an angle of 23° with respect to the resting plane. It consists of a substantially cylindrical body, the top of which is an outer circular crown 10b, which provides centrally a bush-like insert 10c provided with a central hole 10d, of a smaller diameter with respect to crown 10b. Said insert 10c is provided—on the bottom surface thereof—with an annular groove for the housing of the upper end of a spring body 11, apt to maintain the elastic engagement between the two elements.

The engagement between button means 5 and rotating insert 10, and the displacement of the locking pin, occur through the association between a cylindrical drawing pin 12, provided with a dovetail insert 12a, and a preloaded pin 13, provided with a retaining bottleneck 13a.

The engagement between the two pins 12, 13 occurs due to the fact that pin 12 is inserted in pin 13 and has a base 12b having a slightly larger diameter than the diameter of retaining bottleneck 13a.

A spring 14 apt to maintain under tension preloaded pin 13 is housed in a chamber 13b provided above said bottleneck 13a.

As a closing to cavity 4b—and as a support of the safety system consisting of the coupling between the button and the rotating insert—there is a shaped flanged body 15, the central hole of which allows the displacement of the locking pin consisting of the portion below the bottleneck of preloaded pin 13.

The manoeuvring element 1 according to this specification is easy to operate, particularly referring to FIGS. 4a-4c.

FIG. 4a shown manoeuvring element 1 in operating position: the safety system is entirely drawn back, and the operator can proceed with the displacement according to his/her needs. When the operator wishes to lock in the required position manoeuvring element 1, he applies on button 5 the pressure necessary for compressing springs 11 and 14 and for causing rotating insert 10 and button 5 to translate along cavity 4b. Once arrived at the maximum compression of spring 11, insert 10—for the particular engagement which has arisen between the bottom surface 5c of button 5 and the teeth 10a of insert 10—is caused to rotate, so that teeth 10a insert in a suitable protrusion of the inner wall of cavity 4b. At the same time, spring 14, compressed, tends to push out preloaded pin 13.

Once this first step has been completed, the operator will be able to rotate the key, so that lock assembly 6 causes the exit of pin 6a, and the consequent insertion into the suitable perforations provided on the body to displace.

The release of the safety system of the manoeuvring element will banally occur through the sole rotation of the key, with the resulting re-entry into home position of the lock assembly, and the consequent pressure on the button, which releases teeth 10a from the engagement position, and consequently to bring back the spring to the original position, with the consequent traction of the pin.

In case there is no perfect alignment between pin 13 and the complementary hole provided on the moving body on which the manoeuvring element is mounted, spring 14 is compressed and pin 13 is preloaded. Causing the manoeuvring element to rotate, the operator necessarily brings pin 13 in correspondence of the hole, understandably determining the release of spring 14 and the stable insertion of pin 13 into the hole.

As can be understood, by the system just described a manoeuvring element has been obtained provided with safety means such as to keep the bulk constant, both during movement and at rest.

Preferably, to keep the bulk to a minimum, the crank provides an ascending gradient from the gripping area to the engagement area.

It is understood that there may be other embodiments of the manoevring element according to the invention, different from the one described and illustrated in detail above, which achieve a usefulness equal to the ones described. For example, it is not necessary for the manoeuvring element to consist of a crank such as the one just described: it may be a steering wheel in a disc form or with spokes, or a device with two or three arms, with or without manoeuvring handle. Moreover, the locking means can be applied on the element in a position different from the one shown. Finally, a number of buttons greater than one may be provided. All these variants fall in the scope of protection of the present invention.

1) Manoeuvring element of the type consisting of a crank provided at one end of a protruding handle and at the other end of manoeuvring means which actuate a transmission shaft of the rotation and furthermore provided with a safety system, consisting of button means housed in a cavity obtained in said crank for the actuation of a locking pin wherein with said button means there are associated retaining means of said locking pin axially controlled by said button means and apt to rotate between a fastening position and an unlocking position.

2) Manoeuvring element as claimed in claim 1) wherein said button means consist of a cylindrical body open below, from the inner surface of the upper part of said cylindrical body projects centrally a glass element, provided on the outer lateral surface with engaging ribbings with complementary grooves provided along the walls of said cavity in which said button means are housed, and bearing on the bottom surface a wavy pattern.

3) Manoeuvring element as in claim 1) wherein said retaining means consist of a rotating insert consisting of a centrally drilled, substantially cylindrical body, externally provided with equidistant pins, the top surface of which is angled with respect to the resting plane.

4) Manoeuvring element as in claim 1) wherein the angulation of said pins is of 23°.

5) Manoeuvring element as in claim 1) wherein said rotating insert provides on the top an outer circular crown which centrally carries a bush internally provided with an annular groove for the housing of a spring body.

6) Manoeuvring element as in claim 1) wherein the engagement between said button means and retaining means occurs through a pin provided above with a dovetail insert, apt to engage with the central hole of said rotating insert and to engage with said glass of said button means.

7) Manoeuvring element as in claim 6) wherein said pin is associated with said locking pin, having the shape of a preloaded pin provided with a retaining bottleneck, said first pin being inserted into said locking pin and having a base having a slightly larger diameter than that of said retaining bottleneck.

8) Manoeuvring element as in claim 1 wherein that a flanged body is further provided apt to close said safety system below said cavity housing, the central hole of said flanged body being apt to allow the displacement outside said cavity of said locking pin.

9) Manoeuvring element as in claim 1 wherein first spring means apt to maintain the elastic engagement between said button means and said basic flanged body and second spring means apt to maintain the elastic engagement between said button means and said locking pin are furthermore provided.

10) Manoeuvring element as in claim 9) wherein said second spring means are apt to guarantee the correct displacement of said locking pin.
